(19) United States
(12) Patent Application Publication
(10) Pub. No.: US 2026/0086378 A1
(43) Pub. Date: Mar. 26, 2026

(54) VARIABLE LIGHT APODIZER

(71) Applicant: OSELA INC., Montreal (CA)

(72) Inventors: Francis Cayer, Montreal (CA); Alexandre Germain, Montreal (CA); Frederic Monet, Montreal (CA)

(73) Assignee: OSELA INC., Montreal, QC (CA)

(21) Appl. No.: 19/340,099

(22) Filed: Sep. 25, 2025

Related U.S. Application Data
(60) Provisional application No. 63/698,827, filed on Sep. 25, 2024.

(51) Int. Cl. G02B 27/09; G02B 26/02

(52) U.S. Cl. CPC G02B 27/0927; G02B 26/02; G02B 27/0938; G02B 27/0916

(57) ABSTRACT

A variable light apodizer for apodizing a light beam is provided and includes at least one side filter disposed across a path of the light beam. Each side filter has a light transmission profile along an axis transverse to the propagation axis which is maximum from a first edge of the light beam up to a transition point within the light beam and gradually decreases from the transition point to a second edge of said light beam. The variable light apodizer further includes a filter-moving assembly having at least one mechanical mount one which are secured the side filters. Each mechanical mount is movable according to a motion shifting the light transmission profile of the side filter or filters thereon along the corresponding transverse axis. This motion provides a variable apodization of an edge portion of the light beam along the corresponding transverse axis.

### TECHNICAL FIELD

The technical field generally relates to beam shaping components and more particularly concerns a variable light apodizer.

### BACKGROUND

According to electromagnetic propagation theory, the divergence of a light beam is inversely correlated to the physical dimensions of the light source generating the beam. This is because smaller light sources generate beams with a wider angular spread. Diffraction effects, which are more pronounced with smaller sources, cause the light beam to spread out more as it propagates. As the dimension of a light source is intrinsically linked to its divergence, those skilled in the art typically use light sources with a single-mode intensity profile combined with beam shaping techniques and optical collimation to generate light beams having both the desired beam divergence and beam dimensions. The ideal result is a light beam having an intensity profile with a single, well-defined peak without secondary lobes or parasitic light and optical noise surrounding the beam. Achieving a single-mode profile ensures a clean and precise beam, which is required for many applications. The most common single-mode profile known to provide a clean and precise beam latter is the Gaussian profile, also referred to as the fundamental TEM00 mode. The transverse intensity profile and cross-sectional profile of a Gaussian beam are respectively shown in FIGS. 1A and 1B (PRIOR ART). Other examples of useful profiles can include, but are not limited to, a super-Gaussian profile, (FIG. 1C-PRIOR ART), or a Lorentzian profile (FIG. 1D-PRIOR ART).

The intensity profile of a Gaussian beam is commonly described by theory as having a width w₀, known as the waist (see FIG. 1A). The waist, along with the wavelength A of the light beam, determines the divergence θ of the beam, as per equation (1) below:

$${w}_{0} = \frac{4 λ}{π θ} \qquad ( 1 )$$

The evolution of the divergence of the beam over propagating distance is illustrated in FIG. 1E (PRIOR ART). The divergence of the beam is directly correlated to the beam size generated from the source of the light beam, whether it is in a collimated part of the propagation, at the focal plane of the source, or in its near-field or far-field regions.

Repeatability of output divergence characteristics from one unit light source to the next is typically problematic. For example, optical fiber lasers and diode-pumped solid-state lasers (DPSS) can generate light beams with a few degrees of variation from unit to unit of the divergence at 1/e², while variations from unit to unit of single-mode diodes is even greater. The light beams generated by single-mode diodes also have intensity profiles exhibiting sidelobes and have a shape which is not always high-quality Gaussian fit (typically defined as above 90%). The Gaussian fit can be described as the least square minimization of the experimental signal to the best theoretical Gaussian curve. FIGS. 2A to 2D (PRIOR ART) show examples of Gaussian fits, below (FIGS. 2A to 2C) and above (FIG. 2D) the 90% high-quality threshold. In addition, many light sources generate light beams exhibit asymmetrical behavior, an example of which being illustrated in FIG. 2E (PRIOR ART). In this case, one side of the beam appears to have a higher divergence then the other. One of the consequences of this asymmetry is that the centroid of the beam profile does not match the peak position.

Challenges met by those in the art in obtaining light beams having the desired characteristics, particularly significant when using laser diodes as light sources, involve the following difficulties:
ensuring repeatable specifications across multiple assemblies, as each sub-component may have inherent variability;
delivering beam dimension specifications that precisely match application requirements, in particular when the number of possible configurations is limited by the scarce availability of off-the-shelf sources and aspheric lenses; and
providing an assembly that neither clips nor truncates the beam and does not induce sidelobes or aberrations.

The ability to shape a single peak beam so that every assembly produces the same output dimensions, with customizable precision and symmetry as well as no sidelobes and diffraction effect, is advantageous for many applications. This capability could simplify the integration of lasers into more complex systems. For example, in imaging systems, there is a need to adjust the properties of the laser source to match the footprint/aperture of the system, eliminating the need to account for variations in the laser source properties. For target-specific applications, the beam properties need to precisely match the sample or target area dimensions for each unit. As an example, referring to FIGS. 3A and 3B (PRIOR ART) show a light beam 20 incident on a target photodiode 24 part of an array 26 of photodiodes. In the example of FIG. 3A, the light beam 20 has undesired sidelobes 22, whereas the light beam 20 of FIG. 3B is of dimensions mismatched to the target photodiode compared to a light beam 20′ of suitable dimensions. In both cases, undesirable light is likely to impinge on photodiodes of the array 26 of photodiodes neighboring the target photodiode 24. In another example of application, for machine vision and microscopy, custom beam dimensions without aberrations are desired, which can be of particular important when inspecting components having highly reflective surfaces, on which sidelobe reflections can be undesirably seen as a second laser peak. In another possible scenario, an asymmetrical distribution of the beam intensity profile could lead to a slight offset in reconstructed images in imaging applications.

Several solutions are available in the prior art to address the issues described above, each with there own limitations.

One approach known in the art is the use of hard-edge solution, such as irises or slits to truncate or reduce the beam dimensions, hence reducing its divergence. Such an approach however leads to diffraction effects, producing secondary fringes and patterns at the focal plane and in the near-field and far-field. Custom aspherical lenses are often used to collimate a light beam to desired dimensions. Such lenses are however expensive to customize, and cost-mitigating high-volume replication of the design implies a lack of flexibility between units. Off-the-shelf units have limited numerical aperture (NA) possibilities. This limits the design options on available aspheric lenses and the NA limit of the aspheric lenses, which will create a hard-edge. This is illustrated in FIG. 3C (PRIOR ART), where a light beam 20 from a laser source 27 is collimated by an aspheric lens 28 that clips a light beam 20. Such an arrangement typically creates sidelobes at the focal plane of an imaging lens (see FIG. 3D—PRIOR ART) as well as in the near-field and/or far-field (see FIG. 3E—PRIOR ART).

Other approaches to act on the beam intensity profile or dimensions such as apodization, beam expansion or reduction or the like all have similar drawbacks, such as low of adaptability, poor quality of the results and high manufacturing or integration costs.

There remains a need in the art for a solution that alleviates at least one of the drawbacks of the prior art.

### SUMMARY

In accordance with one aspect, there is provided a variable light apodizer for apodizing a light beam. The variable light apodizer having a frame of reference defined by a propagation axis Z for receiving the light beam therealong and by X and Y transverse axes orthogonal to each other and to the propagation axis. The variable light apodizer comprises:
at least one side filter disposed across a path of the light beam, each side filter having a light transmission profile along a corresponding one of the transverse axes which is maximum from a first edge of the light beam up to a transition point within the light beam and gradually decreases from said transition point to a second edge of said light beam; and
a filter-moving assembly comprising at least one mechanical mount having one or more of the at least one side filter being secured thereon, each of the at least one mechanical mount being movable according to a motion shifting the light transmission profile of the one or more side filter thereon along the corresponding transverse axis, wherein said motion provides a variable apodization of an edge portion of the light beam along the corresponding transverse axis.

In some implementations, the transition point is positioned past a center point of the light beam from the first edge thereof.

In some implementations, each of the at least one side filter comprises one of an absorptive material, a partially reflective material, a diffractive filter or a polarization-based filter.

In some implementations, each of the at least one side filter comprises, successively: an inner anti-reflection coating;
a planar glass substrate;
a thin metallic film; and
an outer anti-reflection coating.

In some implementations, the at least one side filter comprises a first X-axis side filter and a second X-axis side filter, the light transmission profiles of said first and second X-axis side filters being maximum at opposite extremities and gradually decreasing in opposite directions along the X transverse axis. Furthermore, in some implementations, the at least one side filter comprises a first Y-axis side filter and a second Y-axis side filter, the light transmission profiles of said first and second Y-axis side filters being maximum at opposite extremities and gradually decreasing in opposite directions along the Y transverse axis.

In some implementations, the at least one filter provides an asymmetrical correction along the corresponding transverse axis.

In some implementations, at least one of the at least one side filter is a dual-axes side filter.

In some implementations, at least one of the at least one mechanical mount is a translation mount configured to translate the one or more of the side filters thereon along the corresponding transverse axis.

In some implementations, at least one of the at least one mechanical mount is a tilting mount configured to tilt the one or more of the side filters thereon around the propagation axis.

In some implementations, the at least one side filter comprises a circular opening or a slit in a plane transverse to the propagation axis.

In accordance with another aspect, there is provided an optical system comprising:
a light source generating a light beam; and
a variable light apodizer for apodizing the light beam, the variable light apodizer having a frame of reference defined by a propagation axis Z receiving the light beam therealong and by X and Y transverse axes orthogonal to each other and to the propagation axis, the variable light apodizer comprising:
   at least one side filter disposed across a path of the light beam, each side filter having a light transmission profile along a corresponding one of the transverse axes which is maximum from a first edge of the light beam up to a transition point within the light beam and gradually decreases from said transition point to a second edge of said light beam; and
   a filter-moving assembly comprising at least one mechanical mount having one or more of the at least one side filter being secured thereon, each of the at least one mechanical mount being movable according to a motion shifting the light transmission profile of the one or more side filter thereon along the corresponding transverse axis, wherein said motion provides a variable apodization of an edge portion of the light beam along the corresponding transverse axis.

In some implementations, the light source comprises a laser diode.

In some implementations, the optical system further comprises at least one lens between the light source and the variable light apodizer.

In some implementations, each of the at least one side filter of the variable apodizer comprises one of an absorptive material, a partially reflective material, a diffractive filter or a polarization-based filter.

In some implementations, the at least one side filter of the variable apodizer comprises a first X-axis side filter and a second X-axis side filter, the light transmission profiles of said first and second X-axis side filters being maximum at opposite extremities and gradually decreasing in opposite directions along the X transverse axis.

In some implementations, the at least one side filter of the variable apodizer further comprises a first Y-axis side filter and a second Y-axis side filter, the light transmission profiles of said first and second Y-axis side filters being maximum at opposite extremities and gradually decreasing in opposite directions along the Y transverse axis.

In some implementations, at least one of the at least one mechanical mount is a translation mount configured to translate the one or more of the side filters thereon along the corresponding transverse axis.

In some implementations, at least one of the at least one mechanical mount is a tilting mount configured to tilt the one or more of the side filters thereon around the propagation axis.

In some implementations, the transition point is positioned past a center point of the light beam from the first edge thereof.

Other features and advantages will be better understood upon of reading of detailed embodiments with reference to the appended drawings.

### BRIEF DESCRIPTION OF THE DRAWINGS

FIGS. 1A and 1B (PRIOR ART) are representations of the transverse intensity profile and the cross-sectional profile of a Gaussian beam; FIGS. 1C and 1D (PRIOR ART) are representations of the transverse intensity profile of a super-Gaussian light beam and a Lorentzian light beam, respectively; FIG. 1E (PRIOR ART) is a representation of the evolution of the divergence of a Gaussian light beam over propagating distance.

FIGS. 2A to 2D (PRIOR ART) show examples of Gaussian fits on the intensity profiles of example light beams, below (FIGS. 2A to 2C) and above (FIG. 2D) the typical 90% high-quality threshold; FIG. 2E (PRIOR ART) shows an example of an asymmetrical intensity profile.

FIGS. 3A and 3B (PRIOR ART) show light beams with side lobes and mismatched dimensions incident on a target photodiode; FIG. 3C (PRIOR ART) is a schematical representation of a light beam collimated by an aspheric lens that clips a light beam; FIGS. 3D and 3E (PRIOR ART) show the resulting intensity profile of the light beam in the near-field and far-field, respectively.

FIG. 4 is a schematic representation of a variable light apodizer in the optical path of a light beam; FIGS. 4A and 4B are representations in the XZ and YZ planes, respectively, of an optical system according to one embodiment; FIG. 4C shows the conversion of the intensity profile of a light beam by the optical system of FIGS. 4A and 4B.

FIG. 5 is a view in the XZ plane of a variable light apodizer according to one embodiment.

FIGS. 6A to 6C are examples of light transmission profiles of variable light apodizers.

FIGS. 7A and 7B are views in the XZ and YZ planes, respectively, of a variable light apodizer with four side filters according to one embodiment.

FIGS. 8A and 8B are examples of the variable light apodizer of FIGS. 7A and 7B with four side filters with the X-axis side filters in different positions; FIGS. 8C, 8D and 8E show the light intensity profile of the light beam propagating through the variable light apodizer of FIGS. 7A and 7B are the input plane A and the output planes B and C, respectively.

FIGS. 9A and 9B show the transmission function of the variable light apodizer of FIGS. 7A and 7B in the positions illustrated in FIGS. 8A and 8B, respectively.

FIGS. 10A and 10B show the thickness profile and the corresponding light transmission profile of a side filter according to one embodiment.

FIG. 11 is a cross-sectional representation in the XZ plane of a side filter according to one embodiment.

FIG. 12 is a schematic representation of variable light apodizer with two mechanical mounts according to one embodiment; FIGS. 12A and 12B are cross-sectional views of the variable light apodizer of FIG. 12 along planes A-A and B-B, respectively.

FIG. 13 is a schematic representation in the XZ plane a set of a first and a second X-axis side filters in a configuration in which both side filters are almost centered; FIGS. 14A and 14B show the thickness and the light transmission profiles the first X-axis side filter of FIG. 13; FIGS. 14C and 14D show the thickness and the light transmission profiles the second X-axis side filter of FIG. 13; and FIG. 15 shows the effect of the side filters of FIG. 13 on the light transmission intensity profile of the light beam.

FIG. 16 is a schematic representation in the XZ plane of the same set of side filters of FIG. 13 in a different position; FIGS. 17A and 17B show the thickness and the light transmission profiles the first X-axis side filter of FIG. 16; FIGS. 17C and 17D show the thickness and the light transmission profiles the second X-axis side filter of FIG. 16; and FIG. 18 shows the effect of the side filters of FIG. 16 on the light transmission intensity profile of the light beam.

FIG. 19 is a schematic representation in the XZ plane of the same set of side filters of FIGS. 13 and 16 in a position correcting an asymmetrical light beam; FIGS. 20A and 20B show the thickness and the light transmission profiles the first X-axis side filter of FIG. 19; FIGS. 20C and 20D show the thickness and the light transmission profiles the second X-axis side filter of FIG. 10; and FIG. 21 shows the effect of the side filters of FIG. 19 on the light transmission intensity profile of the light beam.

FIG. 22 is a schematic representation in the XZ plane of a variable light apodizer having dual-axes side filters; and FIGS. 23A and 23B show the light transmission profiles of the side filters of the variable light apodizer of FIG. 22.

FIGS. 24A and 24B show two examples of sandwich layers which may be used as dual-axes side filters.

FIGS. 25 and 26 is a schematic representation in the XZ plane of a variable light apodizer on a tilting mechanical mount in an un-tilted (FIG. 25) and tilted (FIG. 26) position. FIGS. 25A and 26A show the corresponding light transmission profiles.

FIGS. 27 and 28 is a schematic representation in the XY plane of a variable light apodizer with a circular opening in an un-tilted (FIG. 27) and tilted (FIG. 28) position. FIGS. 27A and 28A show the corresponding light transmission profiles.

FIG. 29 is a schematic representation in the XY plane of a variable light apodizer with a slit opening.

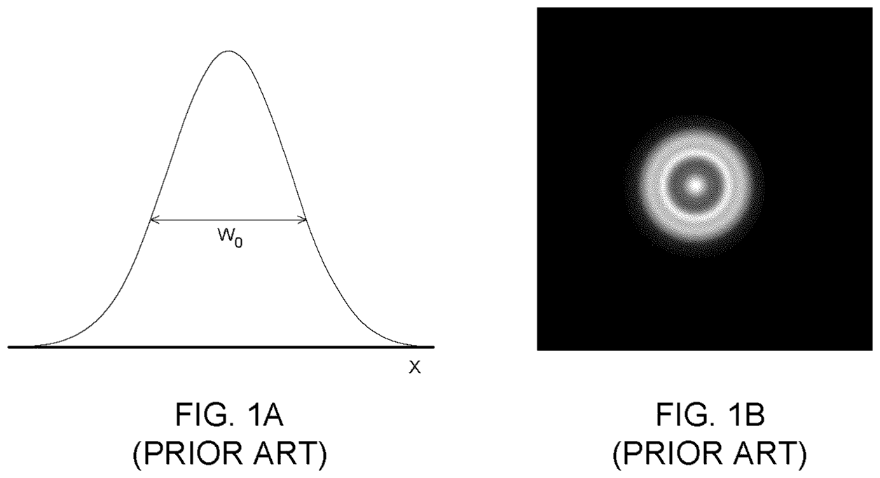

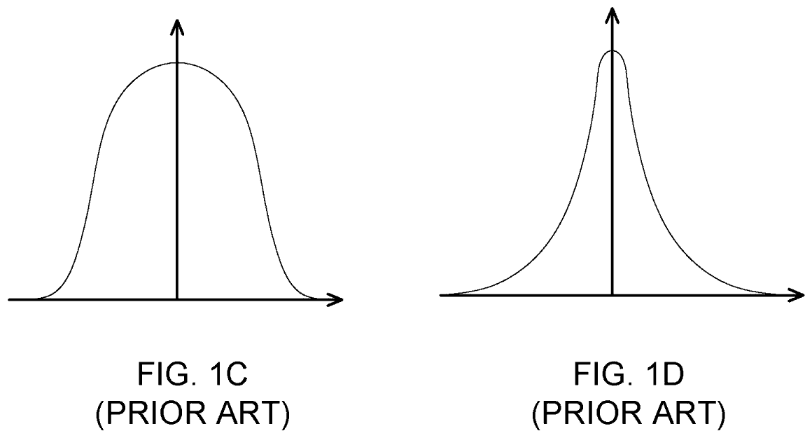

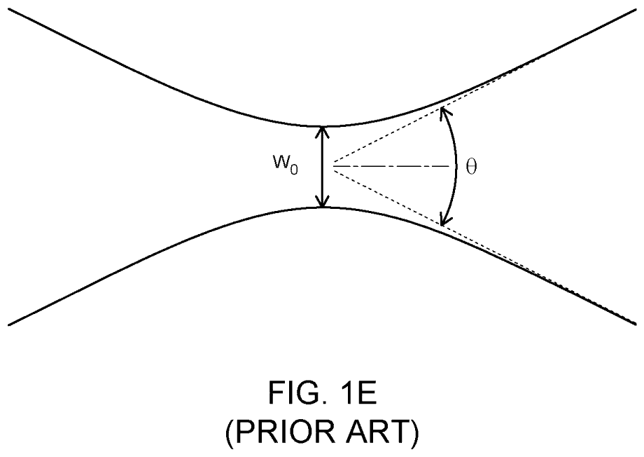

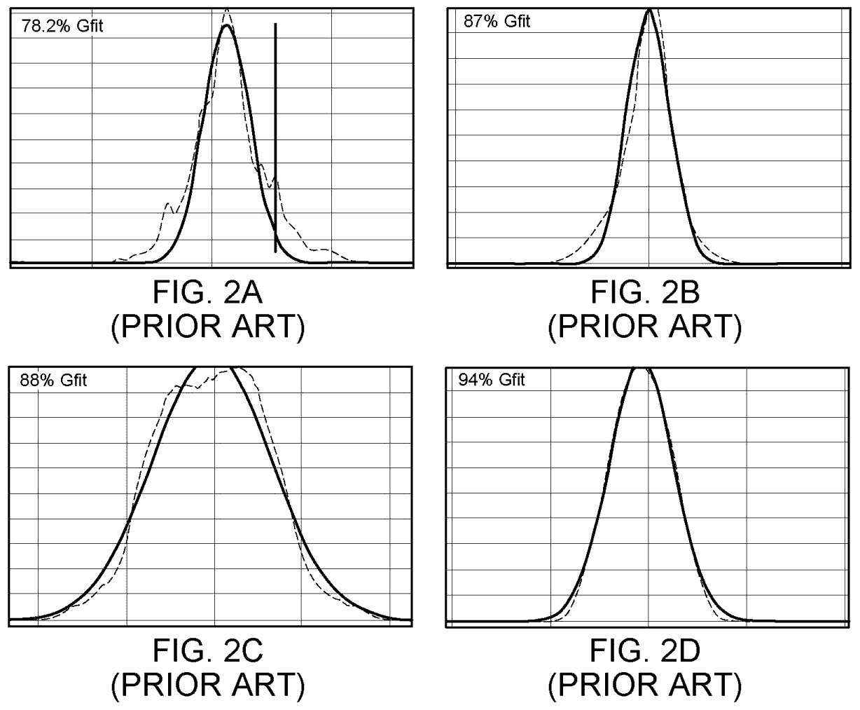

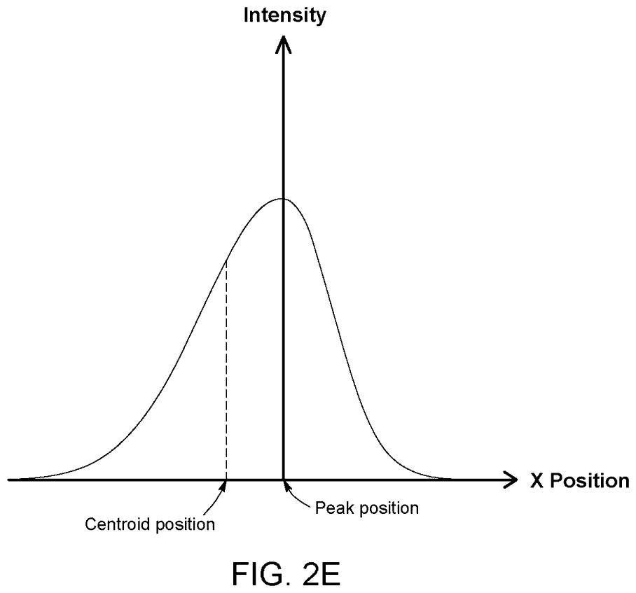

### DETAILED DESCRIPTION

In the following description, similar features in the drawings have been given similar reference numerals. In order not to unduly encumber the figures, some elements may not be indicated on some figures if they were already mentioned in preceding figures. It should also be understood herein that the elements of the drawings are not necessarily drawn to scale and that the emphasis is instead being placed upon clearly illustrating the elements and structures of the present embodiments.

The terms “a”, “an” and “one” are defined herein to mean “at least one”, that is, these terms do not exclude a plural number of items, unless stated otherwise. Terms such as “substantially”, “generally” and “about”, that modify a value, condition or characteristic of a feature of an exemplary embodiment, should be understood to mean that the value, condition or characteristic is defined within tolerances that are acceptable for the proper operation of this exemplary embodiment for its intended application.

Unless stated otherwise, the terms “connected” and “coupled”, and derivatives and variants thereof, refer herein to any structural or functional connection or coupling, either direct or indirect, between two or more elements. For example, the connection or coupling between the elements may be mechanical, optical, electrical, logical, or any combination thereof.

In the present description, the terms “light” and “optical”, and variants and derivatives thereof, are used to refer to radiation in any appropriate region of the electromagnetic spectrum. The terms “light” and “optical” are therefore not limited to visible light, but can also include, without being limited to, the infrared or ultraviolet regions of the electromagnetic spectrum. Also, the skilled person will appreciate that the definition of the ultraviolet, visible and infrared ranges in terms of spectral ranges, as well as the dividing lines between them, may vary depending on the technical field or the definitions under consideration, and are not meant to limit the scope of applications of the present techniques.

To provide a more concise description, some of the quantitative expressions given herein may be qualified with the term “about”. It is understood that whether the term “about” is used explicitly or not, every quantity given herein is meant to refer to an actual given value, and it is also meant to refer to the approximation to such given value that would reasonably be inferred based on the ordinary skill in the art, including approximations due to the experimental and/or measurement conditions for such given value.

In the present description, the term “about” means within an acceptable error range for the particular value as determined by one of ordinary skill in the art, which will depend in part on how the value is measured or determined, i.e. the limitations of the measurement system. It is commonly accepted that a 10% precision measure is acceptable and encompasses the term “about”.

In the present description, when a broad range of numerical values is provided, any possible narrower range within the boundaries of the broader range is also contemplated. For example, if a broad range value of from 0 to 1000 is provided, any narrower range between 0 and 1000 is also contemplated. If a broad range value of from 0 to 1 is mentioned, any narrower range between 0 and 1, i.e. with decimal value, is also contemplated.

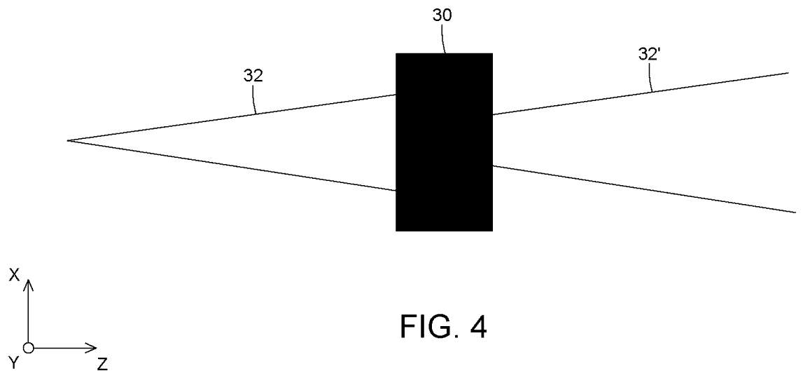

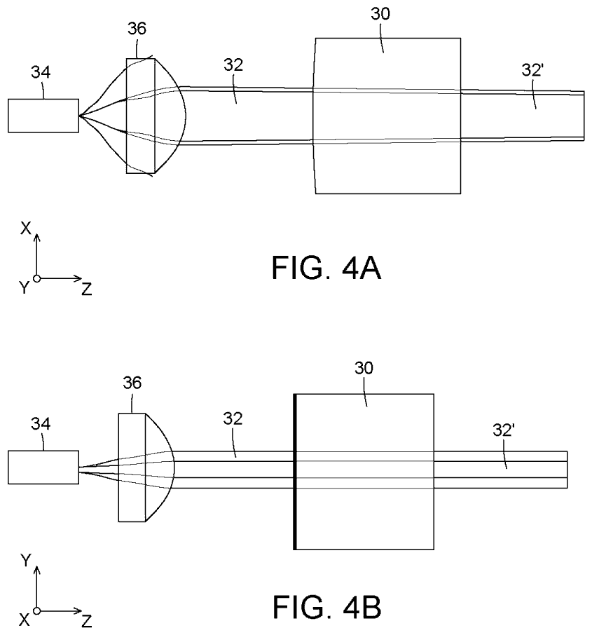

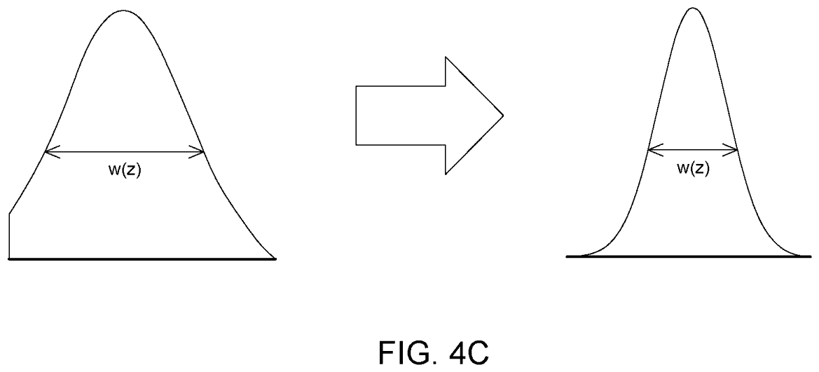

Referring to FIG. 4 in accordance with some aspects, there is provided a variable light apodizer 30 for apodizing a light beam 32.

In the accompanying drawings, the variable light apodizer 30 has a frame of reference defined by a propagation axis Z for receiving the light beam therealong, and by X and Y transverse axes orthogonal to each other and to the propagation axis Z. The designation of the Z axis as coinciding with the light propagation axis is conventional in the art, but other designations may be used. One skilled in the art will readily understand that an XYZ cartesian reference system is being used herein solely for ease of reference and is not meant to impart or imply any preferential orientation to the variable light apodizer. By way of example, while it may be usual in some contexts to associate an axis labelled X with a horizontal axis, in the context of the present description the X axis, and indeed, the Y and Z axes may have any orientation in space with respect to the horizon.

In the fields of optics, as understood by one skilled in the art, apodization generally refers to the imposing of a change in the intensity profile of a light beam. In some implementations, the variable light apodizer 30 may therefore be construed as a device that can change the intensity profile of a light beam 32 in a variable manner, that is, the intensity changes it imposes on the light beam 32 can be adapted to the properties of the light beam 32 at the input of the device and to the desired properties of the output beam 32′ at the output of the device. In some implementations, the variable light apodizer 30 can be seen as acting as a soft-edge aperture. In optics, a hard-edge aperture, such as an iris or truncating aperture, has a sharply defined boundary that abruptly cuts off light, creating distinct and precise edges in the light beam. This can modify the beam dimensions and divergence, but leads to diffraction effects, producing secondary fringes and patterns. In contrast, a soft-edge aperture gradually attenuates the light towards the edge, resulting in a smoother transition and reducing diffraction artifacts. Soft-edge apertures, often used in applications requiring minimal interference patterns, help maintain a cleaner, more uniform beam profile.

Variable light apodizers as described herein may be used in various contexts to improve the properties of light beams. By way of example, in some implementations, the variable light apodizer may be used to correct the divergence of a light beam along one or both axes X, Y orthogonal to the propagation axis Z, for example to obtain a high quality singlemode output beam 32′ with little to no sidelobes. In other implementations, the variable light apodizer 30 may be used to remove sidelobes present along one or both axes X, Y orthogonal to the propagation axis Z with virtually no effect on the divergence of the light beam 32.

In some instances, the variable apodizer 30 may be used in a context wherein a collimating lens 36 or other optics is disposed in a path of a light beam 32. By way of example, FIGS. 4A and 4B are representations in the XZ and YZ planes, respectively, of a light beam 32 from a light source 34, for example a single mode laser diode, passing through an aspheric molded lens 36 to generate a pseudo TEM00 input beam 32, collimated or not. The input beam 32 is incident on and transmitted through the variable light apodizer 30, resulting in an output light beam 32′. Note that the variable light apodizer 30 could be located before or after other optical components (beam shaping optics) that are not depicted in FIGS. 4A and 4B. As shown in FIG. 4C, in some implementations the non-ideal light source properties of the input beam 32 be converted to a non-aberrated mono peak output beam 32′ having steady beam dimension with tolerances of less than 1 μm from unit to unit.

The input light beam 32 may have initial characteristics determined by the light source 34 and any optical component in between, such as for example the collimating lens 36 shown in FIGS. 4A and 4B. The light source 34 may for example be embodied by a single mode diode, a multimode diode, a VECSEL, DPSS, OPSL, an optical fiber laser, a LED, or the like. While in some implementations the light beam 32 may travel directly from the light source 34 to the variable light apodizer 30, in other variants any number of optical components, carrying, redirecting, focussing, collimating, shaping or otherwise affecting the light beam 32 may be provided between the light source and the variable light apodizer 30. In some implementations, the variable light apodizer 30 may be provided as a stand-along component, whereas in other variants it could be part of a larger optical system including the light source 34 generating the light beam 32 and/or any other optical components.

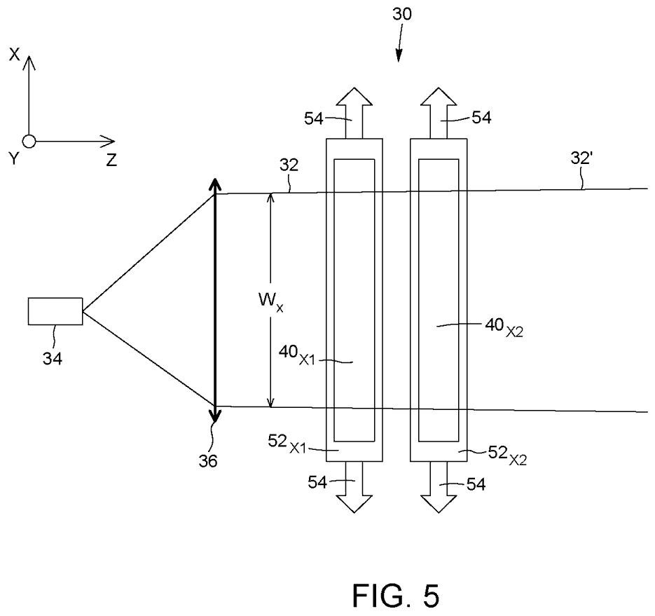

Referring to FIG. 5, a variable light apodizer 30 according to one embodiment is schematically illustrated.

The variable light apodizer 30 includes at least one side filter 40 disposed across a path of the light beam 32. In the variant of FIG. 5, two side filters are provided, referred to herein as the first X-axis side filter 40_{X1} and the second X-axis side filter 40_{X2}. Each side filter 40 preferably extends in the X-Y plane, transversally to the propagation axis Z of the light beam 32.

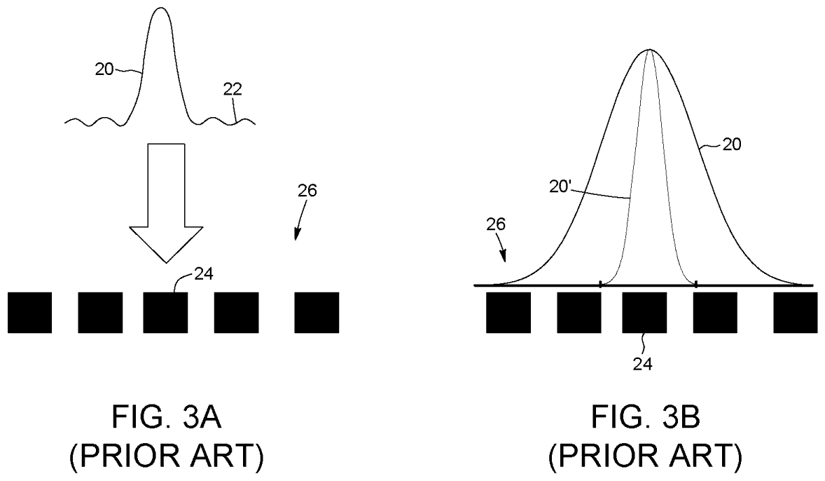

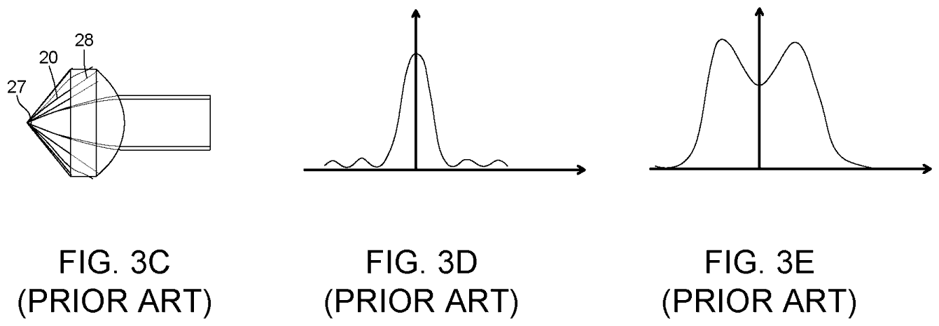

In some implementations, the light beam 32 is understood as propagating along the Z direction and having a transversal spatial profile in the X-Y plane. The light beam 32 may have any dimensions commensurate with the size of the side filters 40. In the example of FIG. 5A, the light beam 32 is generated by a light source 34, for example a singlemode diode, and collimated by a collimating lens 36. The illustrated light beam 32 has a transverse width w_{X} at the entrance of the first X-side filter 40_{X1}. In some implementations, for example illustrated in FIG. 5A, the light beam 32 at the entrance of the variable light apodizer 30, which can be referred to as the input light beam 32, has an initial light intensity profile along an arbitrary transverse axis X which differs from a Gaussian shape, for example an asymmetrically truncated shape such as shown one the left side of FIG. 4C. Uncorrected, this shape would lead to an intensity profile of the output light beam 32′ in near field, far filed and/or at the focal plane of an optical system which would have a central peak of interest and sidelobes on either side of the central peak, such as shown in FIG. 3D. It will however be readily understood that the input light beam 32 may have a different transversal light intensity profile.

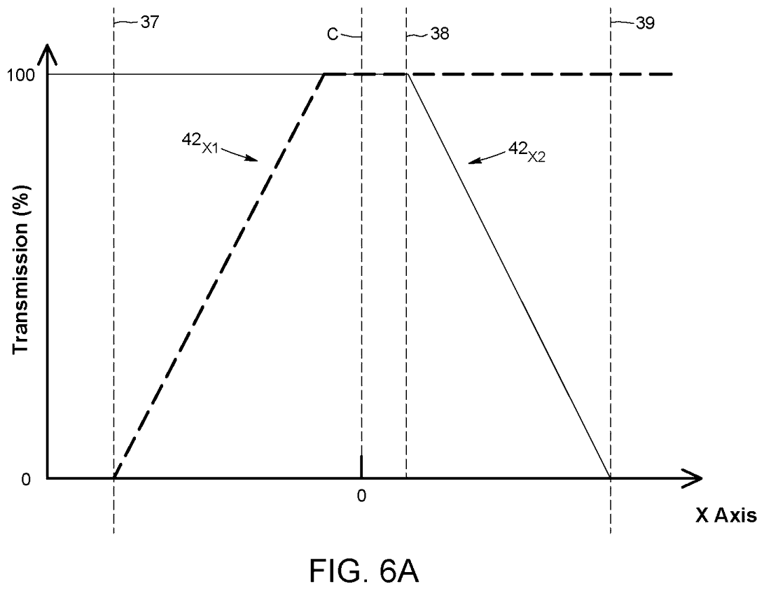

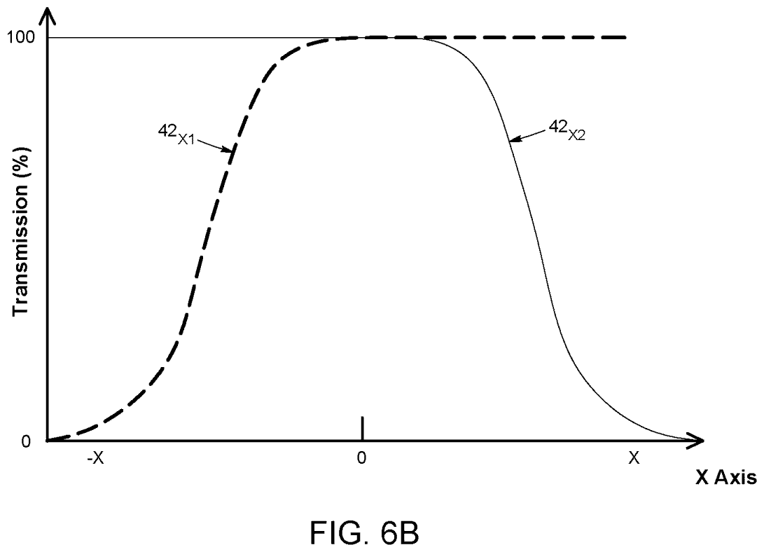

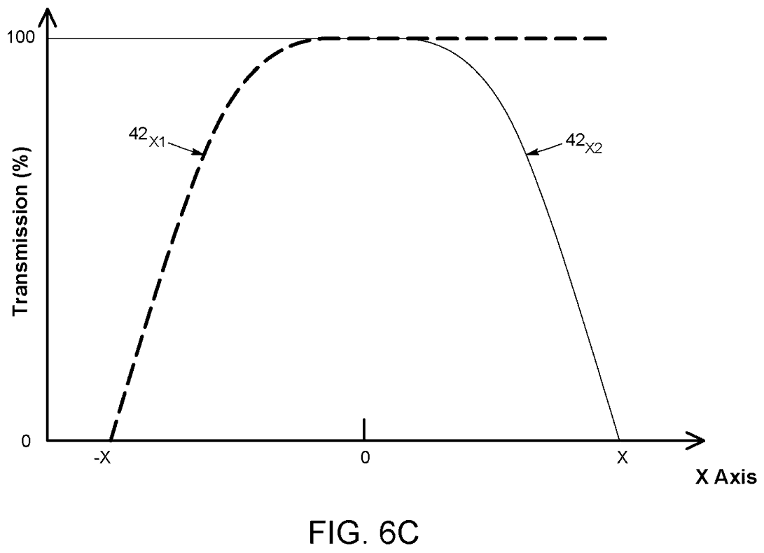

Each side filter 40 has a light transmission profile 42 along a corresponding one of the transverse axes X or Y, as seen by the light beam 32 when impinging thereon. Referring to FIGS. 6A to 6C, examples of light transmission profiles 42_{X1}, 42_{X2} which may be associated with the first and second X-axis side filters 40_{X1}, 40_{X2} of FIG. 5 are shown, using the X axis for reference only (the same profiles can be applied along the Y axis). The light transmission profile 42 of each side filter is maximum from a first edge 37 of the light beam 32 up to a transition point 38, preferably past a center point C of the light beam, and gradually decreases from this transition point 38 to a second edge 39 of the light beam 32.

Referring back to FIG. 5, the variable light apodizer 30 further includes a filter-moving assembly 50. The filter-moving assembly 50 includes at least one mechanical mount 52 having one or more of the side filters 40 being secured thereon. In the example of FIG. 5, the filter-moving assembly 50 includes a first X-axis mechanical mount 52_{X1} on which the first X-axis side filter 40_{X1} is secured, and a second X-axis mechanical mount 52_{X2} on which the second X-axis side filter 40_{X2} is secured. Each mechanical mount 52 is movable according to a motion 54 shifting the light transmission profile 102 of the side filter 40 thereon along the corresponding transverse axis. Referring again to the example of FIG. 5, both the first and second X-axis mechanical mounts 52_{X1} and 52_{X2} are translation mounts, and the corresponding motion 54 is a translation in either direction along the X axis. As explained below, this motion 54 provides a variable apodization of an edge portion of the light beam along the corresponding transverse axis.

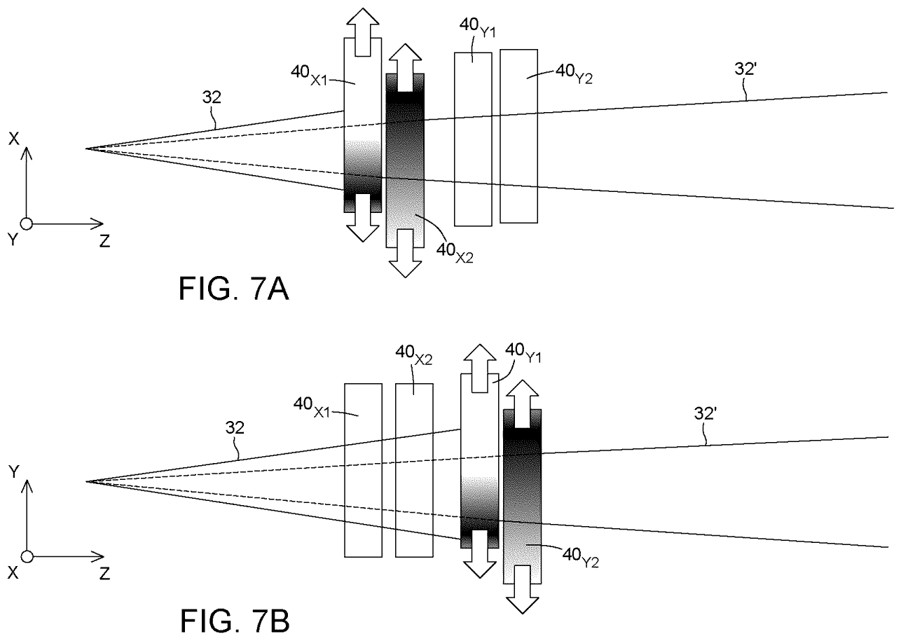

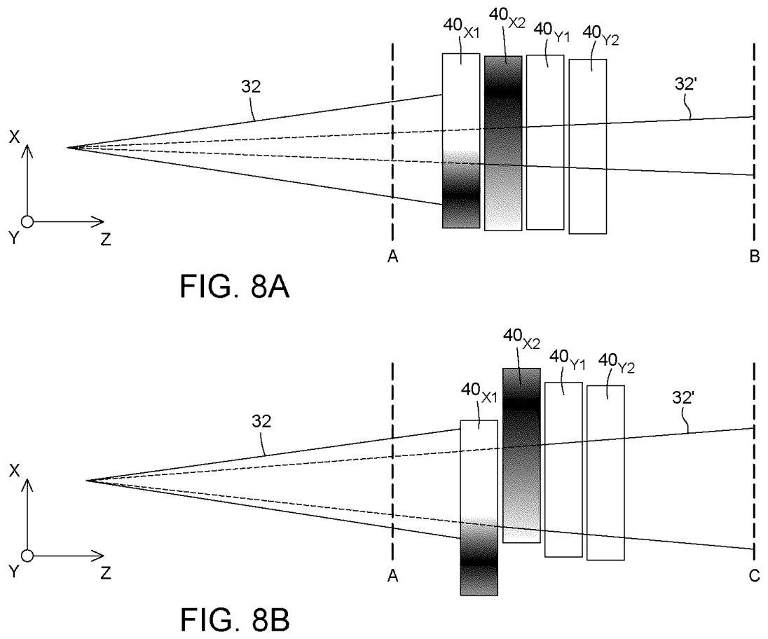

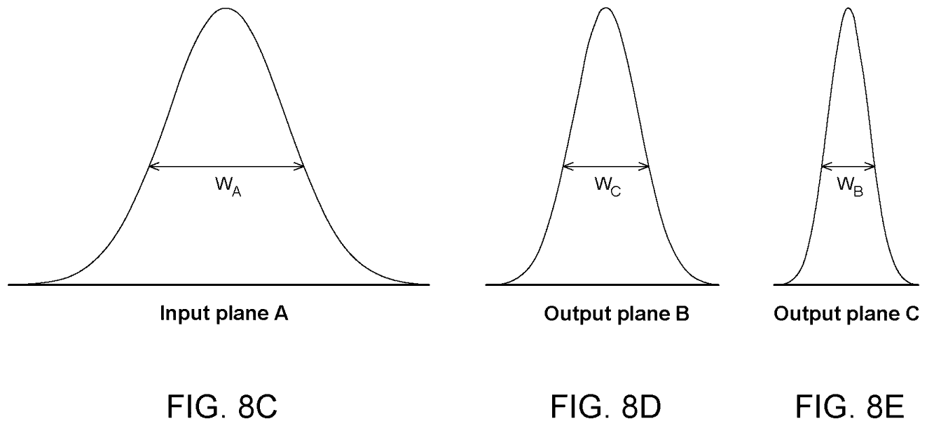

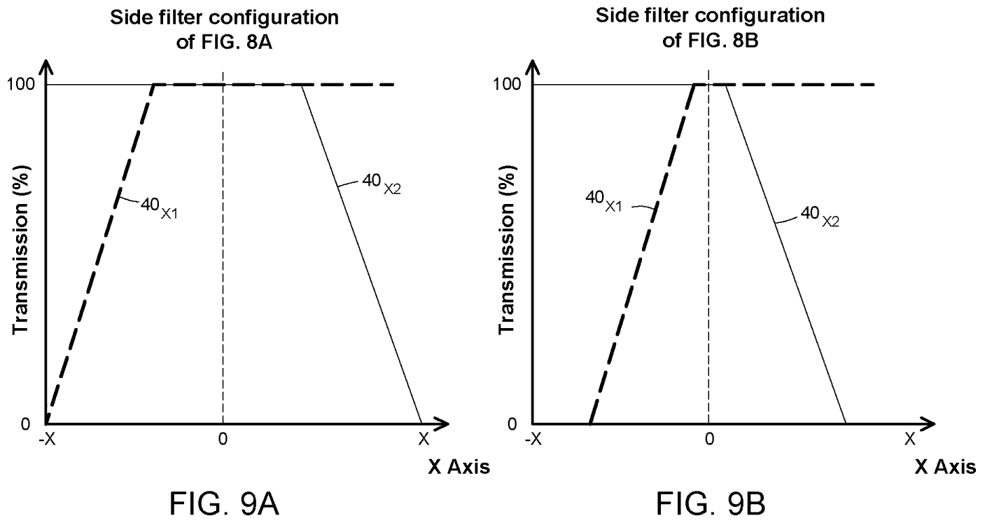

The variable apodizer may include various combinations side filters and mechanical mounts. Referring to FIGS. 7A and 7B, an example is shown with four side filters 40_{X1}, 40_{X2}, 40_{Y1}, and 40_{Y2}. Each of these side filters has a translational adjustment in either the X axis or the Y axis. In some embodiments, two side filters per transverse axis are provided. Each side filter may be embodied by partial transmission optic in such a way that the transmission is maximal at its center and toward one of the extremities of the filter. Toward the other extremity, transmission gradually decreases to 0% with a continuous or non-continuous function that depends on the properties of the side filter. Using this assembly, one can translate each of the side filters (see FIGS. 8A and 8B for an example of two different sets of positions of the X-axis side filters 40_{X1} and 40_{X2}) until the beam dimensions at the input plane A (see FIG. 8C) is apodized and achieves target specifications at the output plane B or C (see FIGS. 8D and 8E). The transmission function of the situation from FIGS. 8A and 8B is illustrated in FIGS. 9A and 9B. Note that the light beam passes through a full substrate at each side filter. Of course, the same principles may be applied along the Y axis, in which case the Y-axis side filters 40_{Y1} and 40_{Y2} are being used.

In some implementations, the transfer functions of the variable apodizer may be expressed as:

$$F ( X , Y ) = 1 , for X , Y position where no apodiztion is required$$

$$F ( X , Y ) = A ( X , Y ) , E [ \begin{matrix}0 & 1\end{matrix} ] , for X , Y position where apodization is required$$

With at least some of the following properties:
A phase shift term may be present, but not related to the system function;
At least one region over which F(X,Y)=1;
Each region where F(X,Y)=1 is of finite dimensions (no singularities such as the center point of any refractive lens);
A(X, Y) is a transmission function and for at least one of these conditions, it decreases to 0:

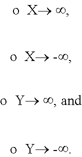

A(X, Y) is a gradually decreasing function over the domain;
A(X, Y)=A(X)*A(Y), meaning A(X) can be split in two independent functions acting solely on X and solely on Y axis.

In some implementations, as mentioned above, each side filter has a transmission profile along the corresponding transverse axis X or Y which is maximum over its central portion and smoothly decreases along one of its outer edges. In some embodiments, a first X-axis side filter and a second X-axis side filter are provided, their light transmission profiles being maximum at opposite extremities and gradually decreasing in opposite directions along the X transverse axis. Alternatively, or additionally, there may be provided a first Y-axis side filter and a second Y-axis side filter, their light transmission profiles being maximum at opposite extremities and gradually decreasing in opposite directions along the Y transverse axis. Referring back to FIGS. 7A and 7B, in the illustrated configuration the variable light apodizer includes:
a first X-axis side filter 40_{X1} that is one sided in the positive X axis;
a second X-axis side filter 40_{X2} that is one sided in the negative X axis;
a first Y-axis side filter 40_{Y1} that is one sided in the positive Y axis;
a second Y-axis side filter 40_{Y2} that is one sided in the negative Y axis.

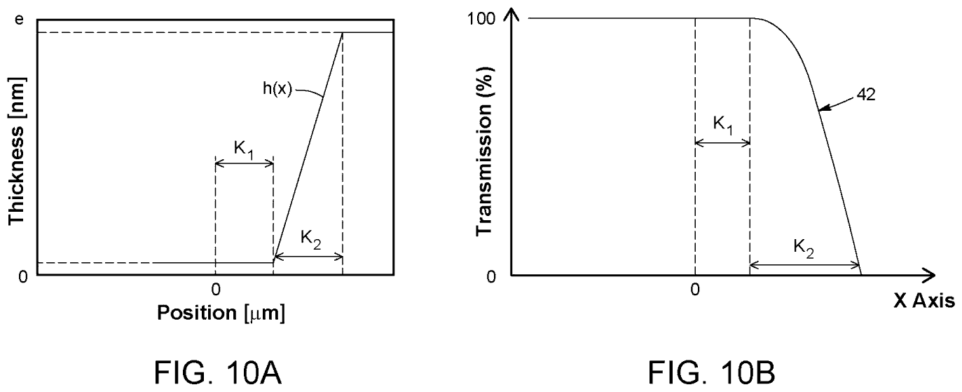

In some embodiments, such as for example shown FIGS. 10A and 10B, the light transmission through a given side filter is directly related to an apodization thickness function h (x) or h (y) as formulated below (only h (x) is shown, h (y) is equivalent). In this example, the a, b, K₁ and K₂ values are common to all filters although this is not mandatory.

$$h ( x ) = 0 , \qquad x < K 1 , \qquad K 1 < 0 or K 1 > 0$$

$$\begin{matrix}h ( x ) = ax + b , & x E [ K 1 , K 1 + K 2 ] , & K 1 \& K 2 < 0\end{matrix} or K 1 \& K 2 > 0$$

$$h ( x ) = e , \qquad x > K 1 + K 2 , \qquad K 1 \& K 2 < 0 or K 1 \& K 2 > 0$$

It will be readily understood that each side filter 40 may have a light transmission profile corresponding to a transmission function differing from the one above and from each other. As an example, for any filter i:

$$h ( x ) = 0 , \qquad x < K {1}_{i} , \qquad K {1}_{i} < 0 or K {1}_{i} > 0$$

$$\begin{matrix}h ( x ) = {a}_{i} x + {b}_{i} , & x E [ K {1}_{i} , K {1}_{i} + K {2}_{i} ] , & K {1}_{i} \& K {2}_{i} < 0\end{matrix} or K {1}_{i} \& K {2}_{i} > 0$$

$$h ( x ) = {e}_{i} , \qquad x > K {1}_{i} + K {2}_{i} , \qquad K {1}_{i} \& K {2}_{i} < 0 or K {1}_{i} \& K {2}_{i} > 0$$

Moreover, the transmission function can be other than linear, such as for any filter i an exponential function of the form:

$$h ( x ) = 0 , \qquad x < K {1}_{i} , \qquad K {1}_{i} < 0 or K {1}_{i} > 0$$

$$\begin{matrix}h ( x ) = {a}_{i} exp ( {b}_{i} x ) , & x E [ K {1}_{i} , K {1}_{i} + K {2}_{i} ] , & K {1}_{i} \& K {2}_{i} < 0\end{matrix} or K {1}_{i} \& K {2}_{i} > 0$$

$$\begin{matrix}h ( x ) = {e}_{i} , & x > K {1}_{i} + K {2}_{i} , & K {1}_{i} \& K {2}_{i} < 0 or K {1}_{i} \& K {2}_{i} > 0\end{matrix}$$

Or for any filter i a polynomial function of the form:

$$h ( x ) = 0 , \qquad x < K {1}_{i} , \qquad K {1}_{i} < 0 or K {1}_{i} > 0$$

$$h ( x ) = {a}_{0 i} + {a}_{1 i} x + … + {a}_{ni} {x}^{ni} ,$$

$$\begin{matrix}x E [ K {1}_{i} , K {1}_{i} + K {2}_{i} ] , & K {1}_{i} \& K {2}_{i} < 0\end{matrix} or K {1}_{i} \& K {2}_{i} > 0$$

$$h ( x ) = {e}_{i} , \qquad x > K {1}_{i} + K {2}_{i} , \qquad K {1}_{i} \& K {2}_{i} < 0 or K {1}_{i} \& K {2}_{i} > 0$$

The side filters may have any design providing the desired light transmission profile. In some implementations, an absorptive material such as an optical filter with the proper transmission function, can be use. The side filters may include partially reflective optic such as a metallic coating which can be made of different material (Inconel, silver, aluminum, without limitation). Partial mirrors may be used, such as dichroic mirrors, as well as anti-reflection coatings having layers of thicknesses that vary with position. The side filters may involve any type of suitably designed spectral bandpass filters with varying bandpass along its position. In some variants, diffractive apodization filters may also be use-by way of example, a grating could be manufactured such that the transmission efficiency on the central order provides the desired light transmission profile. In such embodiments, instead of filtering the light through absorption or reflection, the light is filtered locally by being sent in the higher orders of the grating. Higher orders can than be clipped mechanically. Some embodiments of the side filters may also be based on polarisation schemes. By way of example, an array of waveplates combined with a polarizer can achieve the desired apodization. Similar results may be obtained from an array of prisms which alter the angle of incidence of the light incident on a polarizer. Variable polarizers, having polarizing properties varying along one or more transverse axes, may also be use. LCDs (liquid crystal devices) act similarly by using electrical current to modify the liquid crystal refractive properties. Coupled with two orthogonal polarizers, one can modulate the light intensity transmission across the array of LCDs.

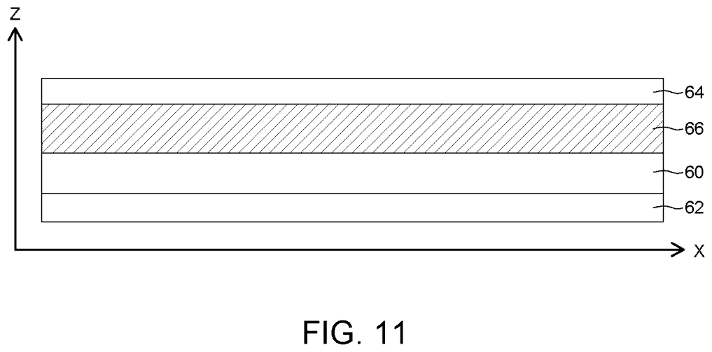

Referring to FIG. 11, using an X-axis side filter as an example, in some implementations one or more of the side filters 40 may be made of a planar glass substrate 60 sandwiched between inner and outer Anti-Reflection (AR) coatings 62, 64 (usually MGF₂) and a thin film metallic deposition 66. The outer AR coating layer 64, above the thin metallic film 66, also acts as a protection for the thin metallic film 66 against dust, contamination and oxidation. The thin metallic film 66 may have a thickness vs position function h (X) that respects the conditions on the transfer function F (x) defined above, such as for example shown in FIG. 10A, and FIG. 10B shows the resulting light transmission profile 42. The metallic thin film may for example be evaporated aluminum deposited using an ebeam evaporation system. Again, although only X axis is illustrated in FIG. 11 the same principles can be applied to the Y axis. In some variants, additional coating layers can be provided for other purposes.

In some implementations, the side filters 40 along the X, axis, Y axis or both may be designed to provide an asymmetrical correction along the corresponding axis. In asymmetrical correction implementations, only one side filter may be provided along one or both of the X and Y axes. Designating the zero-position at the propagating beam centroid, the single side filter would thus only correct either the positive X (or Y) position along the light beam or the negative X (or Y) position along the light beam. In other variants, two side filters having different transmission functions (not just a mirror symmetry one from the other) may be provided along a same axis.

Each mechanical mount may be embodied by any device apt to induce the desired motion on the side filter or side filters mounted thereon. By way of example, electromechanical devices such as electrical drive linear motion mounts or piezoelectric crystal linear movement mounts may be used. In some implementations, the mechanical mount may be provided with one or more fine adjustment mechanisms such as dovetails or linear translation slots with push/push, pull/pull or push/pull screws, or ball bearing or crossed roller bearing linear translation mechanisms. Additionally or alternatively, the mechanical mount may be provided with one or more coarse adjustment mechanisms such as a female dovetail with a sliding adjustment of a male part, a translation slot with a visual sliding adjustment or a positioning of the side filters in a mechanical recess with dimensions along the relevant axis greater than the filter dimensions. More than one side filter may be mounted on a given mechanical mount.

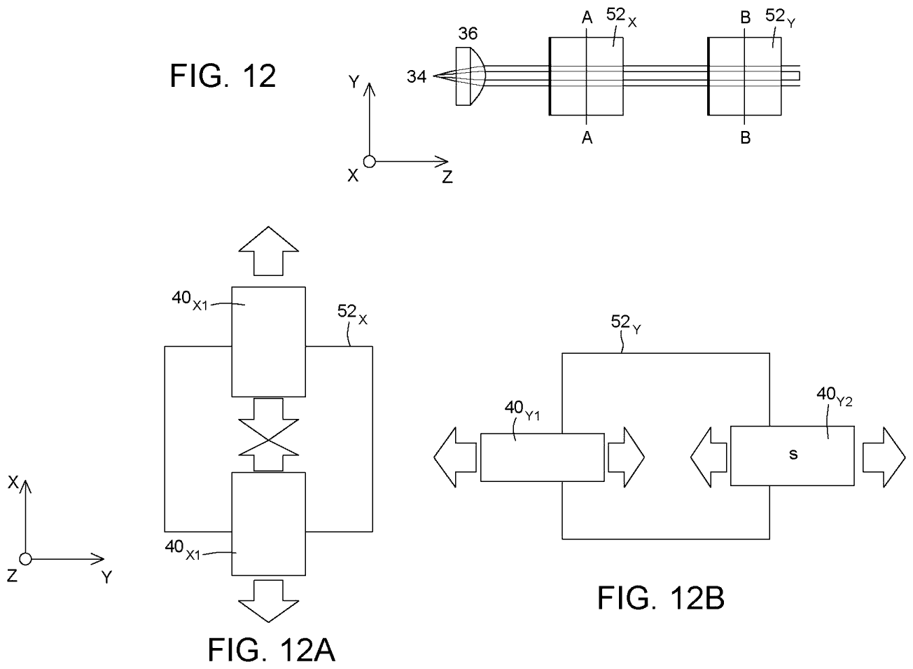

Referring to FIGS. 12, 12A and 12B there is shown an example of configuration of the variable light apodizer in which two mechanical mounts are provided, an X-axis translation mount 52_{X} configured to translate the X-axis side filters 40_{X1}, 40_{X2} independently of each other in either direction along the X-axis, and a Y-axis translation mount 52_{Y} configured to do the same for the Y-axis side filters 40_{Y1}, 40_{Y2}. Each translation mount 52_{X} and 52_{Y} may be placed before or after other components such as beam shaping optics. The number of mechanical mounts and side filters per mount could vary depending on the requirements of a given system. By way of example, four different mounts may be used, a single side filter being mounted on each mount. In other variants, the variable apodizer may include two mounts, one with three side filters and one with a single side filter. In some implementations, only one, two or three side filters may be provided. In some implementations, each or some of the individual side filters could be split in sub-components.

### Additional Examples of Configurations

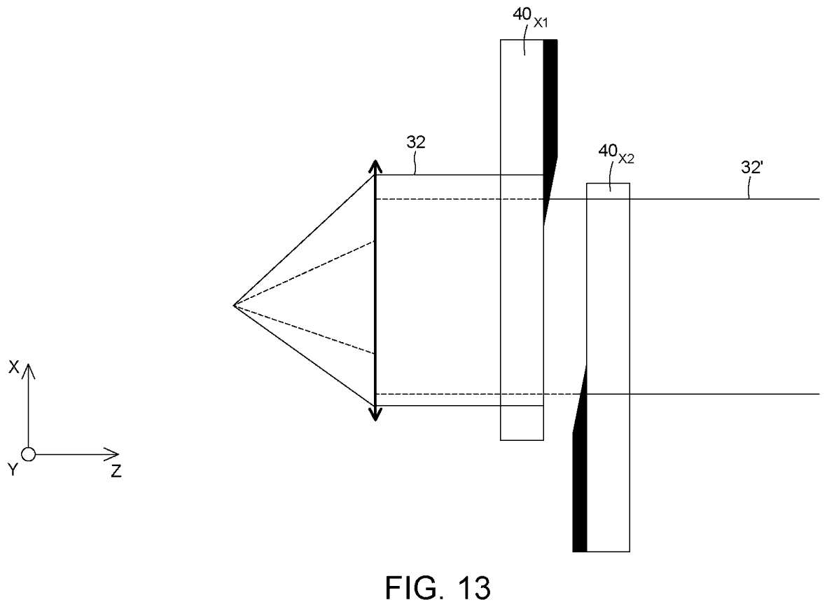

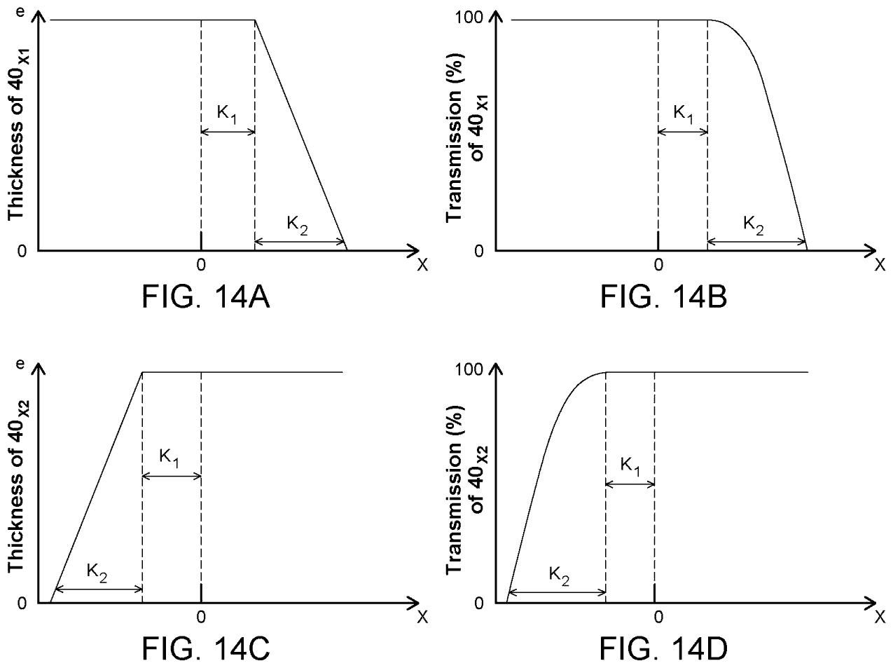

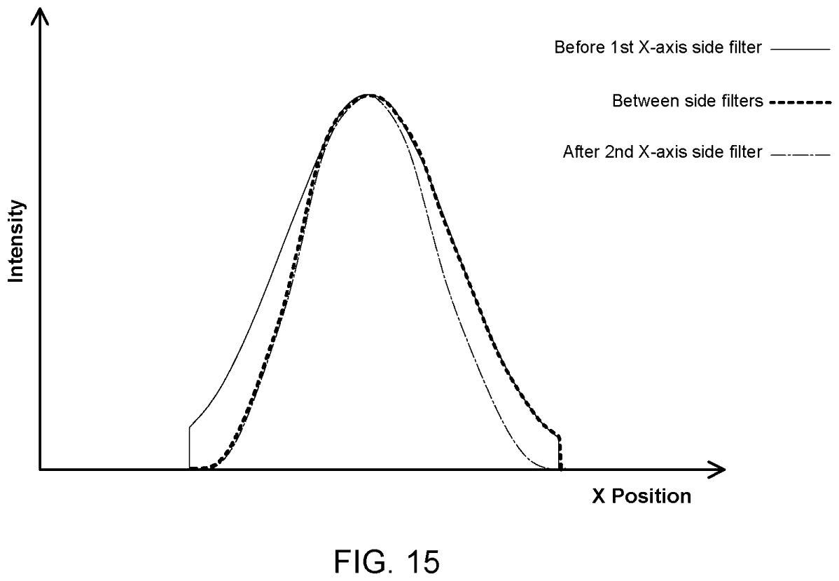

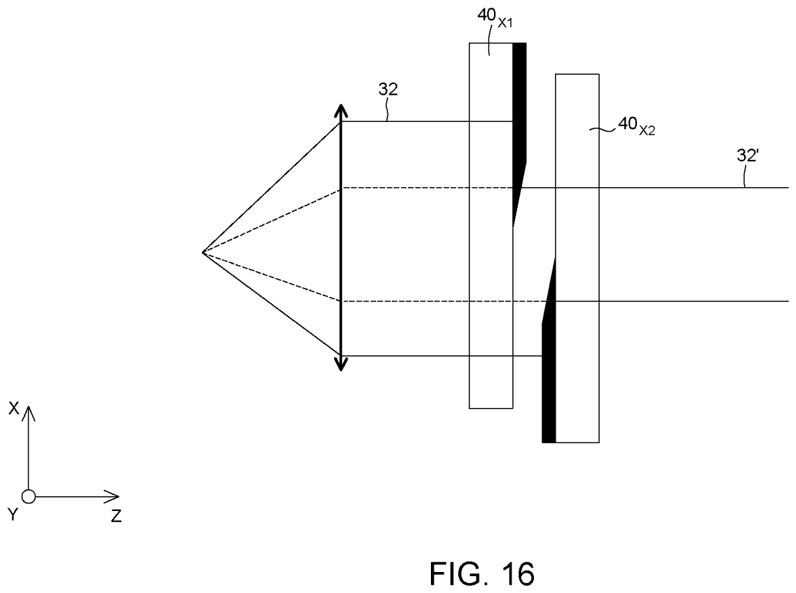

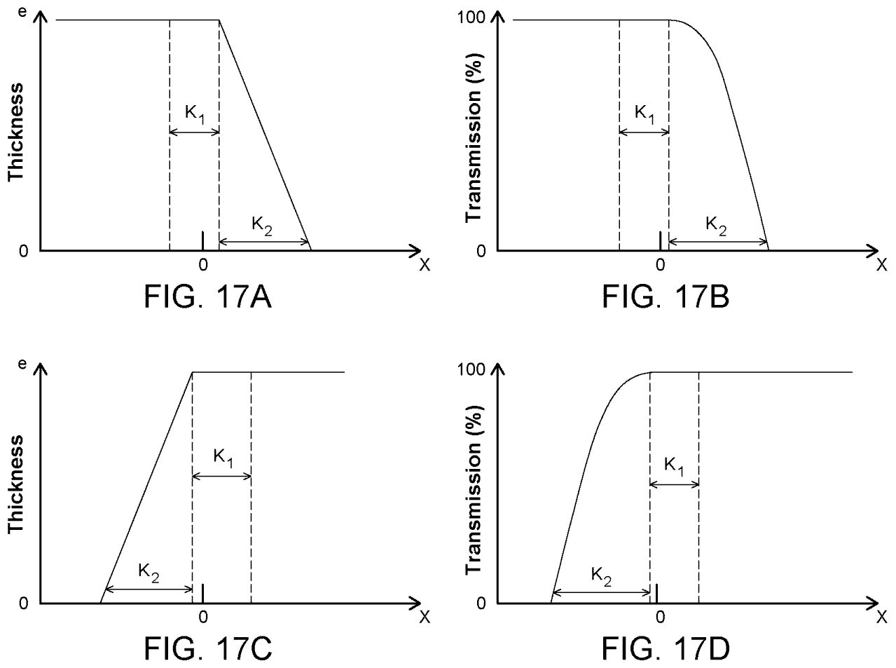

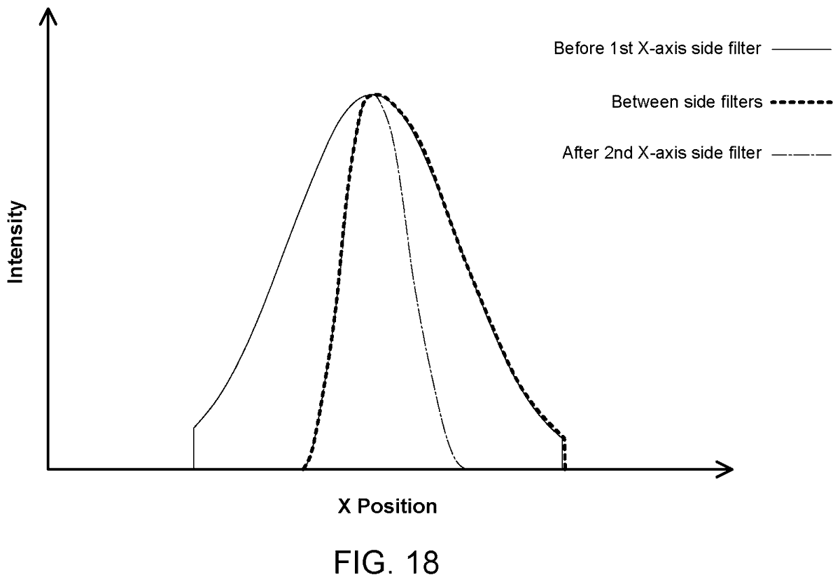

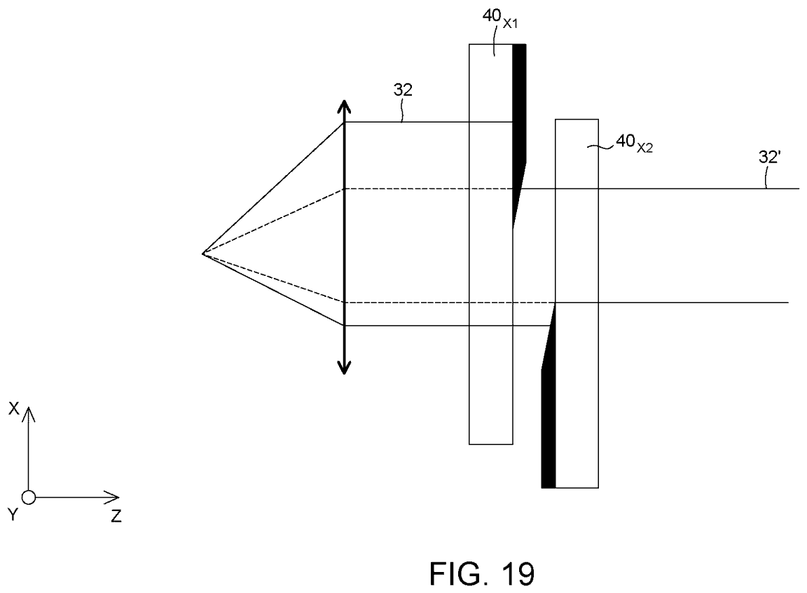

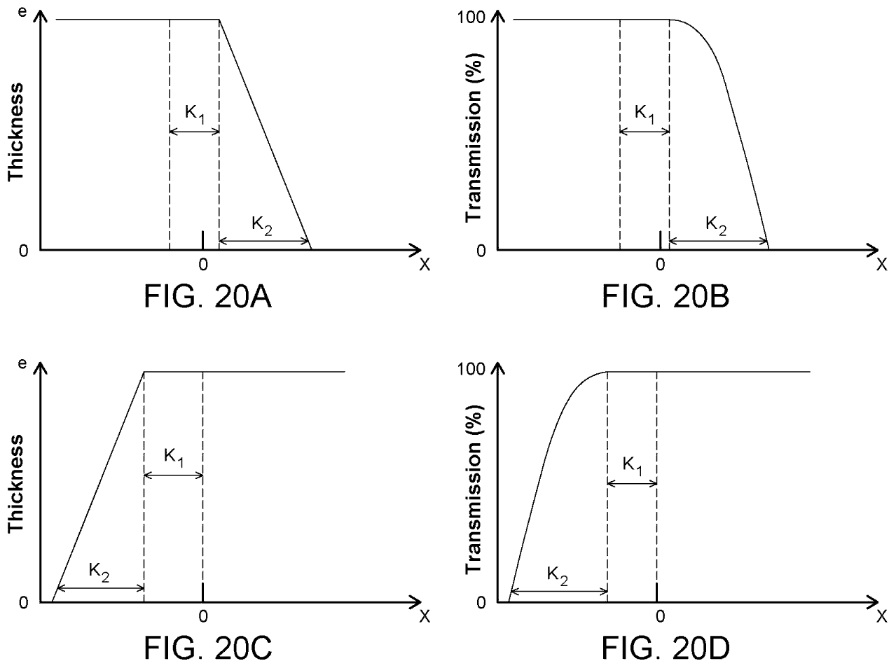

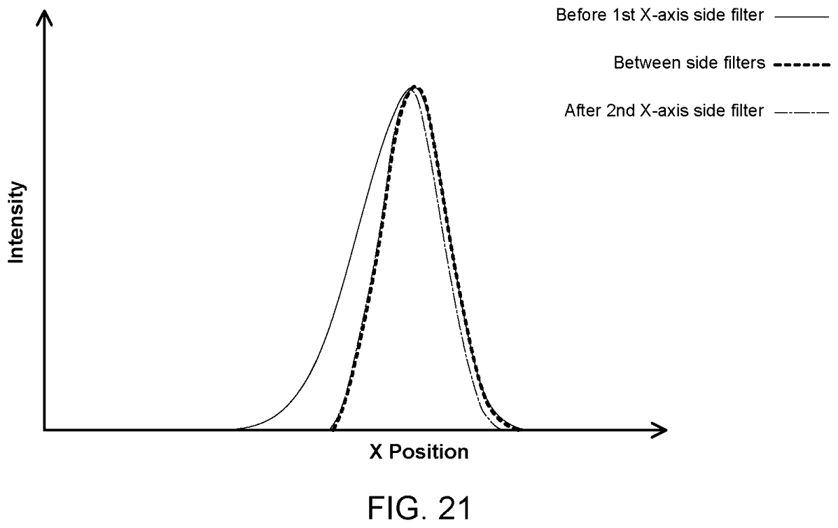

FIG. 13 shows a set of a first and a second X-axis side filters 40_{X1} and 40_{X2} in a first configuration in which both side filters are almost centered, resulting in only a slight correction of the light beam 32. The thickness and the light transmission of both side filters are illustrated in FIGS. 14A and 14B for the first X-axis side filter 40_{X1}, and FIGS. 14C and 14D for the second X-axis side filter 40_{X2}. The effect of these side filters on light transmission along the X axis is depicted in FIG. 15, as the light beam 32 passes subsequently through the two side filters. Moving each side filter towards the center from opposite directions along the X axis can make the output light beam 32′ smaller (to lower the divergence). FIG. 16 shows the same filter arrangement as FIG. 13 wherein the side filters have been moved more inward. The corresponding thickness and transmission profiles are shown in FIGS. 17A and 17B and the resulting effect on the light beam in FIG. 18. In effect, each side filter act on ‘one side’ of the light beam along the corresponding transverse axis. When the placement of each side filter is optimized, the effect is usually symmetrical (required by most applications) but may be not, as illustrated in FIGS. 19, 20A to 20D and 21, where the side filters are used to correct a case where the input light beam 32 is asymmetrical.

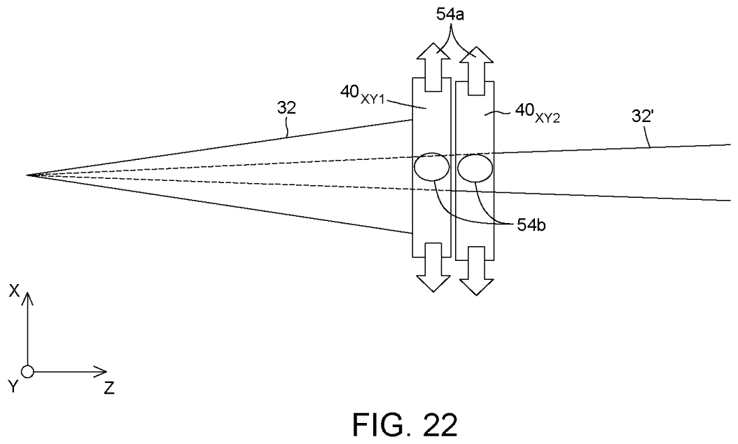

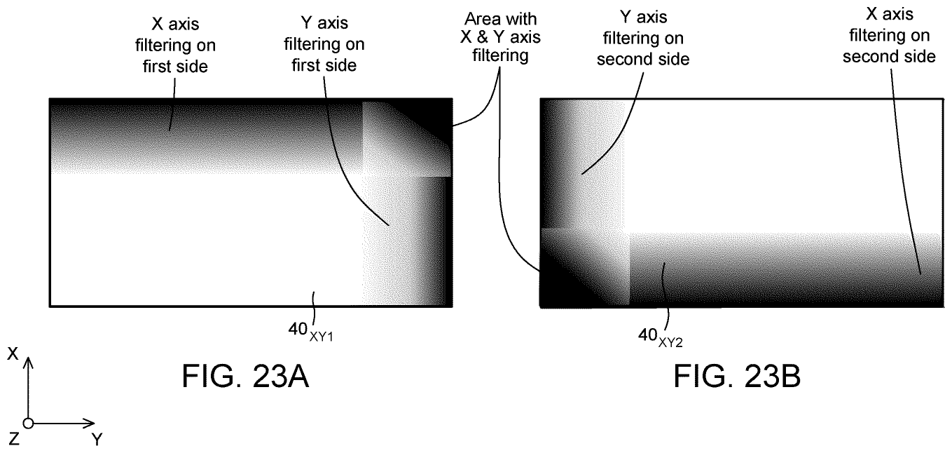

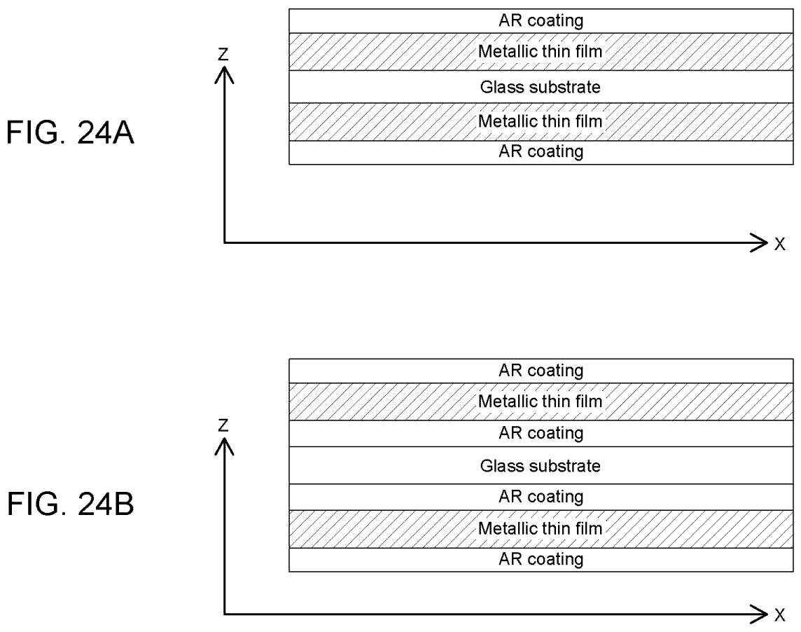

Referring to FIG. 22, in some embodiments the at least one side filter may include one or more dual-axes side filters having a continuous light transmission profile as defined above along both the X axis and the Y axis. The illustrated embodiment of FIG. 22 shows two dual-axes side filters 40_{XY1} and 40_{XY2}, whose bidimensional light transmission profile is shown in FIGS. 23A and 23B, respectively. In this example, the first dual-axis side filter 40_{XY1} provides apodization on a first side along both the X axis (on the right in the image of FIG. 23A) and the Y axis (on the top in the image of FIG. 23A), while the second dual-axis side filter 40_{XY2} provides apodization on a second side along both the X axis (on the left in the image of FIG. 23B) and the Y axis (on the bottom in the image of FIG. 23B). In other terms, the transmission function of each dual-axes side filter is less than 100% on two domain of two orthogonal axes among Positive X, Positive Y, Negative X, and Negative Y. In some implementations, each dual-axes side filter may be fabricated through deposition of a metallic coating creating the desired light transmission profile along both the X and Y axes on a same substrate. FIGS. 24A and 24B show two examples of sandwich layers which may be used as dual-axes side filters. Referring back to FIG. 22, each dual-axes side filter 40_{XY1} and 40_{XY2} has two translation adjustment: motion 54a in X and a motion 54b in Y (although not mandatory). Advantageously, this embodiment provides the same results as the previously disclosed ones with less Fresnel losses due to less glass-to-air interfaces. This embodiment also simplifies the mechanical integration, reduces the footprint and requires less optical components.

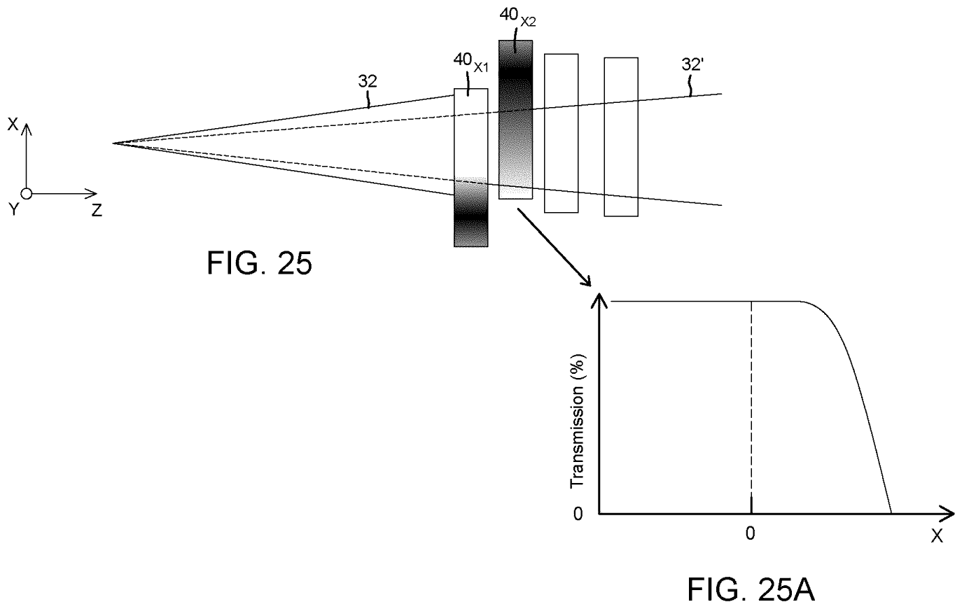

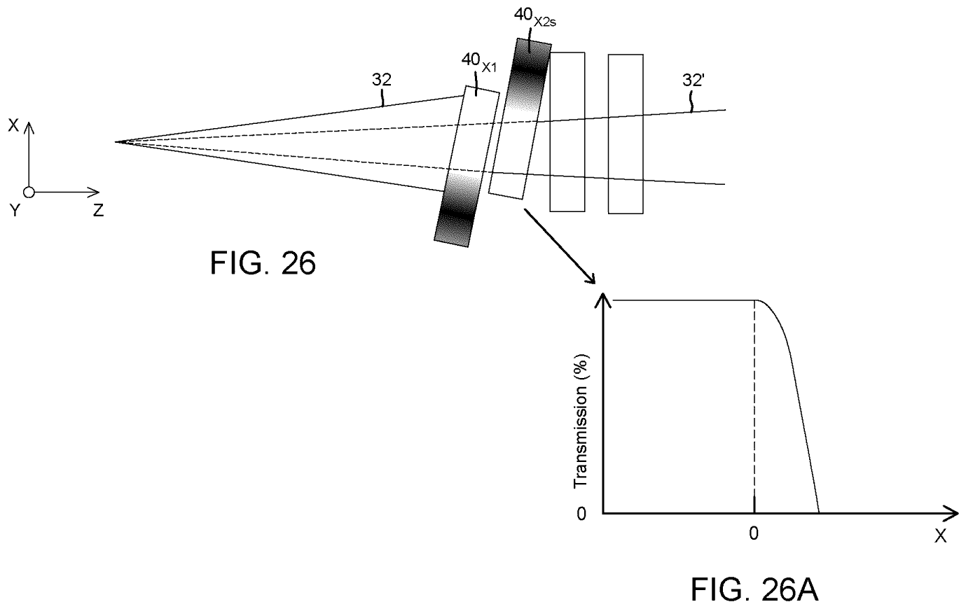

While in the implementations mentioned above the motion imparted by the mechanical mount on the side filters is a translation. In another realization a mechanical tilt of the side filter along the X or Y axis may be used. The mechanical mount may therefore be embodied by a tilting mount configured to tilt one or more of the side filters along the corresponding transverse axis. As one skilled in the art will readily understand, this will have the same effect on light transmission as a translation of the side filters. Referring to FIGS. 25, 25A, 26 and 26A, this is illustrated for only one axis orthogonal to the propagation axis, although it is the same principle for both axes. FIG. 25 shows the impact of the un-tilted X-axis side filters 40_{X1} and 40_{X2} on the light beam 32, the light transmission profile seen by the light beam 32 along the X axis being shown in FIG. 25A. For comparison, FIG. 26 shows the same system with the X-axis side filters tilted around the Y axis, and therefore pivoted in the XZ plane, the resulting light transmission profile along the X axis being shown in FIG. 26A.

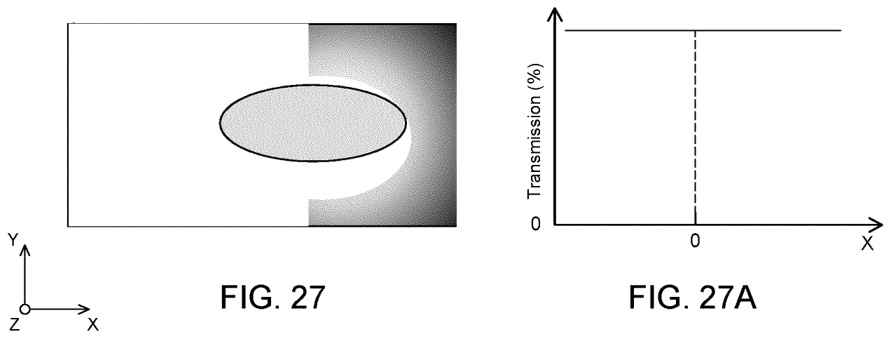

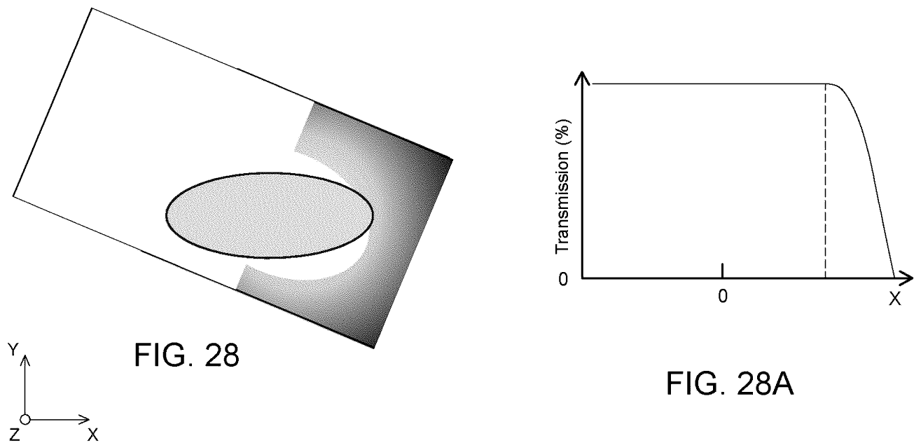

Another approach is to give a circular shape to the apodization film, resulting on a circular opening in a plane transverse to the propagation axis on one or both sides of the light beam. In such an embodiment, the mechanical mount is configured to tilt the side filter around the propagation axis. This is illustrated in FIGS. 27, 27A, 28 and 28A (only one axis orthogonal to the propagation axis is illustrated although it is the same principle for both axes).

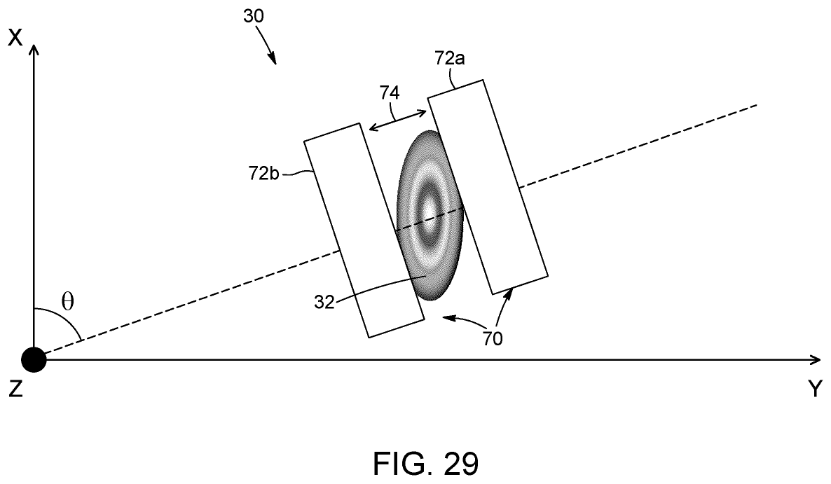

Referring to FIG. 29, in yet another variant, the variable light apodizer 30 may be embodied by a slit 70 tilted at an angle θ with respect to one of the transverse axis X. By way of example, the slit 70 may have a rectangular-shaped opening between side walls 72a, 72b having a gap 74 therebetween slightly smaller than the transverse width w_{X} of the light beam 32 at the entrance of the slit 70. By way of example, the side walls 72a, 72b may be embodied by a pair of apodizing filters having a continuously decreasing transmission profile or a hard edge mask—as will be readily understood by one skilled in the art, even if the hard edge mask would not structurally be considered an apodized filter, its tilted orientation with respect to the effective axis provides a gradually decreasing light transmission along this axis. The net effect of the slit 70 is to block a portion of the light in the outer edges of the light beam 32, leading to the apodization of the light beam along the transverse axis X. In this variant, each side wall 72a, 72b embodies one of the side filters 40. Rotating the slit 70 around the centroid of the light beam 32 varies the width of the gap 74 along the transverse axis X, providing the motion shifting the light transmission profile along the transverse axis X. The mechanical mount is this variant may be embodied by a tilting mount apt to provide the desired rotation motion to the slit 70.

Advantageously, using variable light apodizers according to some of the embodiments described herein, a diffraction free spot is achievable. Relative to the dimension, prior solutions offer around 20% tolerance on the beam dimensions (+/−10% in best scenarios). The solution presented here may achieve, without limitation, less than 2% tolerance for beams smaller than 50 μm at 1/e². and approximately 1-2 μm tolerance for bigger beams, larger than 50 μm at 1/e².

The variable apodizer described herein may be used in various applications related to improving the performance of a light beam and more specifically:
Altering beam divergence/dimension symmetrically in one or two axes orthogonal to the propagation axis while achieving a high-quality, single peak beam with virtually no sidelobes or residual light.
Altering beam divergence/dimension asymmetrically in one or two axes orthogonal to the propagation axis while achieving a high-quality, single peak beam with virtually no sidelobes or residual light.
Removing or cleaning sidelobes in one or two axes orthogonal to the propagation axis with virtually no effect on beam divergence/dimension.

Embodiments described herein specifically addresses correcting the divergence and aberrations of single-mode laser diodes, but it will be readily understood that the fields of application of the variable light apodizer can be much broader.

Embodiments of the variable light apodizer may present the following advantages:
Each side filter may be the same (no need to customize the side filters) or each X-axis side filter is the same and each Y-axis side filter is the same;
Side filters can be easily manufactured with thin film deposition systems;
Low cost & compact solutions;
The translational movement enables to customize transferred beam precisely without customizing the optic (the variable light apodizer). By doing so, the performance is much less sensible to the apodization deposition profile;
Easy and fast to align.

Of course, numerous additional modifications could be made to the embodiments described above without departing from the scope of protection as defined in the appended claims.

1. A variable light apodizer for apodizing a light beam, the variable light apodizer having a frame of reference defined by a propagation axis Z for receiving the light beam therealong and by X and Y transverse axes orthogonal to each other and to the propagation axis, the variable light apodizer comprising:
at least one side filter disposed across a path of the light beam, each side filter having a light transmission profile along a corresponding one of the transverse axes which is maximum from a first edge of the light beam up to a transition point within the light beam and gradually decreases from said transition point to a second edge of said light beam; and
a filter-moving assembly comprising at least one mechanical mount having one or more of the at least one side filter being secured thereon, each of the at least one mechanical mount being movable according to a motion shifting the light transmission profile of the one or more side filter thereon along the corresponding transverse axis, wherein said motion provides a variable apodization of an edge portion of the light beam along the corresponding transverse axis.

2. The variable light apodizer according to claim 1, wherein the transition point is positioned past a center point of the light beam from the first edge thereof.

3. The variable light apodizer according to claim 1, wherein each of the at least one side filter comprises one of an absorptive material, a partially reflective material, a diffractive filter or a polarization-based filter.

4. The variable light apodizer according to claim 1, wherein each of the at least one side filter comprises, successively:
an inner anti-reflection coating;
a planar glass substrate;
a thin metallic film; and
an outer anti-reflection coating.

5. The variable light apodizer according to claim 1, wherein the at least one side filter comprises a first X-axis side filter and a second X-axis side filter, the light transmission profiles of said first and second X-axis side filters being maximum at opposite extremities and gradually decreasing in opposite directions along the X transverse axis.

6. The variable light apodizer according to claim 3, wherein the at least one side filter comprises a first Y-axis side filter and a second Y-axis side filter, the light transmission profiles of said first and second Y-axis side filters being maximum at opposite extremities and gradually decreasing in opposite directions along the Y transverse axis.

7. The variable light apodizer according to claim 1, wherein the at least one filter provides an asymmetrical correction along the corresponding transverse axis.

8. The variable light apodizer according to claim 1, wherein at least one of the at least one side filter is a dual-axes side filter.

9. The variable light apodizer according to claim 1, wherein at least one of the at least one mechanical mount is a translation mount configured to translate the one or more of the side filters thereon along the corresponding transverse axis.

10. The variable light apodizer according to claim 1, wherein at least one of the at least one mechanical mount is a tilting mount configured to tilt the one or more of the side filters thereon around the propagation axis.

11. The variable light apodizer according to claim 10, wherein the at least one side filter comprises a circular opening or a slit in a plane transverse to the propagation axis.

12. An optical system comprising:
a light source generating a light beam; and
a variable light apodizer for apodizing the light beam, the variable light apodizer having a frame of reference defined by a propagation axis Z receiving the light beam therealong and by X and Y transverse axes orthogonal to each other and to the propagation axis, the variable light apodizer comprising:
at least one side filter disposed across a path of the light beam, each side filter having a light transmission profile along a corresponding one of the transverse axes which is maximum from a first edge of the light beam up to a transition point within the light beam and gradually decreases from said transition point to a second edge of said light beam; and
a filter-moving assembly comprising at least one mechanical mount having one or more of the at least one side filter being secured thereon, each of the at least one mechanical mount being movable according to a motion shifting the light transmission profile of the one or more side filter thereon along the corresponding transverse axis, wherein said motion provides a variable apodization of an edge portion of the light beam along the corresponding transverse axis.

13. The optical system according to claim 12, wherein the light source comprises a laser diode.

14. The optical system according to claim 12, further comprising at least one lens between the light source and the variable light apodizer.

15. The optical system according to claim 12, wherein each of the at least one side filter of the variable apodizer comprises one of an absorptive material, a partially reflective material, a diffractive filter or a polarization-based filter.

16. The optical system according to claim 12, wherein the at least one side filter of the variable apodizer comprises a first X-axis side filter and a second X-axis side filter, the light transmission profiles of said first and second X-axis side filters being maximum at opposite extremities and gradually decreasing in opposite directions along the X transverse axis.

17. The optical system according to claim 16, wherein the at least one side filter of the variable apodizer further comprises a first Y-axis side filter and a second Y-axis side filter, the light transmission profiles of said first and second Y-axis side filters being maximum at opposite extremities and gradually decreasing in opposite directions along the Y transverse axis.

18. The optical system according to claim 12, wherein at least one of the at least one mechanical mount is a translation mount configured to translate the one or more of the side filters thereon along the corresponding transverse axis.

19. The optical system according to claim 12, wherein at least one of the at least one mechanical mount is a tilting mount configured to tilt the one or more of the side filters thereon around the propagation axis.

20. The optical system according to claim 12, wherein the transition point is positioned past a center point of the light beam from the first edge thereof.
